(19) United States
(12) Patent Application Publication
(10) Pub. No.: US 2003/0232221 A1
(43) Pub. Date: Dec. 18, 2003

(54) Method of producing sintered bodies, a method of producing shaped bodies, sintered bodies, shaped bodies and corrosion resistant members

(75) Inventors: Hirotake Yamada, Anjyo-City (JP); Kouichi Imao, Kagamigahara-City (JP); Tsutomu Naitou, Kasugai-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/453,853

(22) Filed: Jun. 3, 2003

(30) Foreign Application Priority Data
May 8, 2003 (JP) P2003-129725
Jun. 6, 2002 (JP) P2002-165100

(51) Int. Cl. B32B 9/00; B32B 19/00

(52) U.S. Cl. 428/697; 501/152; 428/701

(57) ABSTRACT

A sintered body having at least a first phase and a second phase contacting one another at an interface is produced. A shaped body having a first shaped phase and a second shaped phase is prepared. The shaped body is sintered to produce the sintered body. A slurry containing a sinterable inorganic powder, a dispersing medium and a gelling agent is filled in a mold and gelled so that the slurry is solidified to provide the first shaped phase.

This application claims the benefits of Japanese Patent Applications P2003-129725 filed on May 8, 2003 and P2002-165100 filed on Jun. 6, 2002, the entireties of which are incorporated by reference.

### BACKGROUND OF THE INVENTION

1. Field of the Invention

The present invention relates to a shaped body having a plurality of shaped portions each made of a ceramics or metal, and the sintered body thereof.

2. Related Art Statement

In a semiconductor manufacturing system in which a super-clean state is necessary, as a deposition gas, an etching gas and a cleaning gas, halogen-based corrosive gases such as chlorine-based gases and fluorine-based gases are used. For instance, in a semiconductor manufacturing system such as thermal CVD system, after the deposition, semiconductor cleaning gases composed of halogen-based corrosive gases such as CIF₃, NF₃, CF₄, HF and HCl are used. Furthermore, in a step of the depositions halogen-based corrosive gases such as WF₆, SiH₂Cl₂ and so on are used as gases for use in film deposition.

Further in a system for producing semiconductors, an article called a shower plate has been known. The shower plate has a ceramic plate-shaped substrate with many through holes formed therein. The shower plate is mounted in a space over a semiconductor wafer, and a halogen gas is supplied into the space over the wafer through the through holes of the shower plate to generate plasma.

### SUMMARY OF THE INVENTION

Accordingly, it is desired that members for use in a semiconductor manufacturing apparatus, for instance, members that are accommodated in the apparatus and an inner wall surface of a chamber are provided with a coating that is high in the corrosion-resistance against a halogen gas and its plasma and stable over a long period of time.

The assignee disclosed, in JP 2002-249864A, that when an yttra-alumina garnet film is formed on a surface of a substrate by use of a spraying method, excellent corrosion resistance against plasma of a halogen gas can be endowed and particles can be suppressed from generating.

However, even in the film, in some cases, the following problems are caused. That is, depending on spraying conditions, it is difficult to form a film having a constant thickness, so that the thickness of the sprayed film may be substantially deviated depending on the positions. If the thickness of the sprayed film is deviated, the properties of the film such as thermal conduction is deviated, so that the stress distribution in the film may be substantially induced leading to the peeling off of the film. Further, according to a spraying method, it is difficult to provide a film having a thickness larger than a specific value. For example, it is extremely difficult to form a sprayed film having a thickness of 0.5 mm or more. Further, it is necessary to from a sprayed film on the surface of a substrate after the substrate is sintered. It is usually needed to carry out a heat treatment for improving the density of the sprayed film to a some degree. Such additional step of heat treatment increases the total manufacturing steps leading to low productivity.

Further in a conventional process of producing a shower plate, a ceramic plate-shaped substrate is ground to from many through holes therein. The grinding process may induce processing damage in the ceramic substrate to generate particles, leading to semiconductor defects. It is thus necessary to prevent the particle generation from the shower plate

An object of the present invention is to provide a process for producing a sintered body having at least first and second phases contacting one another at an interface, so that the dimensional precision and productivity of the sintered body may be improved.

Another object of the present invention is to provide a process for producing a shaped body having at least first and second shaped phases contacting one another at an interface, so that the dimensional precision of the shaped body may be improved.

A first aspect of the present invention provides a method of producing a sintered body comprising at least a first phase and a second phase. The first and second phases contact one another at an interface. The method has the steps of, preparing a shaped body comprising first and second shaped phases, and sintering the shaped body to produce the sintered body. According to the process, a slurry containing a sinterable inorganic powder, a dispersing medium and a gelling agent are filled in a mold, gelled and solidified to provide the first shaped phase

The present invention further provides a sintered body obtained by the above method.

The present invention further provides a method of producing a shaped body having at least a first shaped phase and a second shaped phase. The first and second shaped phases contact one another at an interface. The method has the step of:

filling a slurry containing a sinterable inorganic powder, a dispersing medium and a gelling agent into a mold and gelled and soludified to provide the first shaped phase.

The present invention further provides a shaped body obtained by the above method.

According to the first aspect of the present invention, it is possible to considerably reduce the difference between the measured and designed values in producing the shaped body. For example, when a two-layered structure having a main body and a corrosion resistant layer formed on one face of the main body for the purpose of corrosion resistance, it may be desired that the thickness of a part of the corrosion resistant layer is increased in its design. Even when the thickness is changed in a a part of the corrosion resistant layer, it is possible to obtain a shaped body having a shape similar to a designed shape intended for production. Further, the composite shaped body may be sintered so that the first and second shaped phases are co-sintered. In this case, it is possible to reduce the number of sintering steps needed for producing a final product, to improve the productivity of the sintered body, and to improve the dimensional precision of the sintered body. It is further possible to independently control properties of the first and second phases, such as the material, porosity, kind and composition of crystal phase, and thermal expansion or the like, by adjusting the conditions for producing the slurry.

A second aspect of the present invention provides a corrosion resistant member having a ceramic main body having a hole formed therein and an innermost layer provided on the inner wall face of the member and facing the hole. The innermost layer comprises an anti-corrosive ceramics, and the hole has a diameter of in a range of 0.1 mm to 2 mm and a length of 2 mm or more.

For example, the holes of a shower plate has an elongate shape having a diameter of 2 mm or smaller and a length of than 2 mm or more. When a halogen gas is supplied through the holes into a space over a wafer, particle generation from the wall surface facing the hole is proved to be considerable. The reasons may be considered as follows. The hole has a small diameter so that particle generation due to the processing damage of the inner wall surface facing the hole is substantial. (0017) On the contrary, according to the second aspect of the present invention, each hole has an elongate shape of a diameter of 2 mm or smaller and a length of 2 mm or longer. It has been found that only when the hole with such elongate shape is covered with a corrosion resistant ceramic layer, the particle generation may be substantially reduced. In particular, such advantageous effects are proved to be substantial when the diameter of the hole is 2 mm or smaller and the length is 2 mm or more. The reasons may be considered as follows. When the hole has such elongate shape, the particle generation due to processing damage of the inner wall surface facing the hole may be substantial.

Further, a third aspect of the present invention provides a method of producing a ceramic member having a main body having a hole formed therein and an innermost layer provided on the inner wall face of the member and facing the hole. A mold having an outer frame forming a shaping space and a protrusion protruding into the space is used. A first gel cast slurry generating the innermost layer upon sintering is applied onto the protrusion and solidified. A second gel cast slurry generating the main body upon sintering is cast into the space and solidified so that a shaped body is obtained. The shaped body is then sintered to provide a ceramic member having the main body and innermost layer.

According to the method, it is possible to provide a specific ceramic layer onto the inner wall surface facing the hole without a specific processing. Moreover, a troublesome processing for forming many small holes, for example by grinding, may be omitted, leading to a higher productivity. As described above, a gel cast slurry is used to obtain a shaped body having an innermost layer and the shaped body is then sintered. It is thus possible to control the dimensional precision of the thickness of the innermost layer.

These and other objects, features and advantages of the invention will be appreciated upon reading the following description of the invention when taken in conjunction with the attached drawings, with the understanding that some modifications, variations and changes of the same could be made by the skilled person in the art.

### BRIEF DESCRIPTION OF THE DRAWINGS

FIG. 1 is a flow chart of a manufacturing process according to one embodiment of the present invention.

FIG. 2 is a flow chart of a manufacturing process according to another embodiment of the present invention.

FIG. 3 is a flow chart of a manufacturing process according to still another embodiment of the present invention.

FIG. 4(a) is a front view schematically showing a composite sintered body 1.

FIG. 4(b) is a front view schematically showing a composite sintered body 11.

FIG. 5(a) is a cross sectional view schematically showing a mold 15.

FIG. 5(b) is a cross sectional view showing a mold 15 whose molding space 16 is filled with a gel cast molding slurry 17 for a surface layer.

FIG. 5(c) is a cross sectional view showing a mold 15 in which a gel cast slurry 18 for an innermost layer is applied onto protrusions 15b in the molding space 16.

FIG. 5(d) is a cross sectional view schematically showing the mold in which a gel cast slurry for a main body is filled.

FIG. 6(a) is a cross sectional view schematically showing a sintered body 24 obtained by sintering a shaped body shown in FIG. 5(d).

FIG. 6(b) is a cross sectional view schematically showing a sintered body 24A after small through holes 20 are formed in a sintered body 24 of FIG. 6(a).

FIG. 7 is a flow chart of a manufacturing process in experiment D.

The present invention will be described below further in detail.

According to the one aspect of the present invention, a shaped body is produced having at least first and second phases contacting one another at an interface. A slurry containing a sinterable inorganic powder, a dispersing medium and a gelling agent is filled in a mold and gelled so that the slurry is solidified to shape at least the first phase.

This shaping process of the first phase is referred to as a gel cast molding process. According to the process, a slurry containing a powder of a ceramics or metal, a dispersing medium and gelling agent are molded and gelled with the addition of a crossing agent or adjustment of temperature so that the slurry is solidified to obtain a shaped body.

A gel cast molding process is known as a process for producing a shaped body of powder. However, it has not known to shape the first phase with gel cast molding in producing the shaped body having the first and second phases. It has not also known to co-fire the thus obtained shaped body to produce a sintered body having the first and second phases.

Detained embodiments will be described below. The sintered body of the present invention has the first and second phases. The first phase is made of a material which may be the same as or different from a material for the second phase. The material of the first phase may preferably be different from that of the second phase.

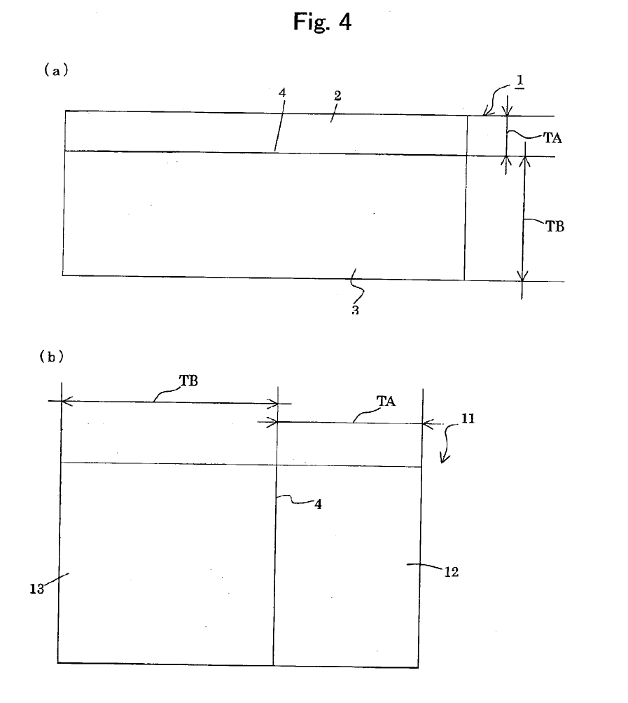

The shape of the first or second phase is not particularly limited. In a preferred embodiment, the sintered body of the invention has a substrate 3 and a film 2 laminated on the substrate, as shown in FIG. 4(a). In this embodiment, either of the substrate 3 and film 2 may be the first phase. Alternatively, the first phase 12 and second phase 13 may be bulky bodies integrated with each other, as shown in FIG. 4(b).

The sintered body according to the present invention may have one or more additional sintered phase other than the first and second phases. The additional phases may have any shape or form not particularly limited. The additional phase may preferably be laminated with the first and second phases. The additional phase may be adjacent with the first phase, or with the second phase, or with both of the first and second phases.

Phases other than the first phase may be shaped by any processes, including gel cast molding described above, cold isostatic pressing, slip casting, slurry dipping, doctor blade and injection molding. The order of shaping steps of the first and second phases is not limited. For example, the first phase is shaped by gel cast molding and the second phase may be then shaped by gel cast molding or the other process to produce the shaped body. Alternatively, the second phase is shaped by gel cast molding or the other process to produce a shaped body, which may be then contained in a mold and the first phase may be then shaped by gel cast molding in the same mold

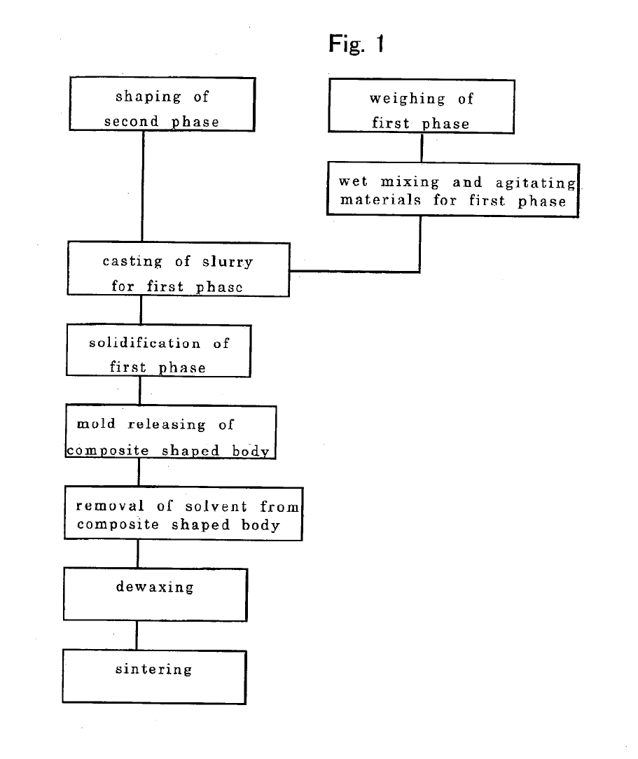

Specifically, as shown in FIG. 1, the second phase may be shaped in advance. That is, the second phase is shaped by gel cast molding or the other shaping process. The raw material of the first phase is weighed, wet mixed anid agitated to obtain a slurry. The shaped body of the second phase is contained in a mold, into which the slurry for the first phase is supplied and solidified to produce a composite shaped body. The shaped body is removed from the mold. After the solvent and binder of the body are removed, the body is sintered.

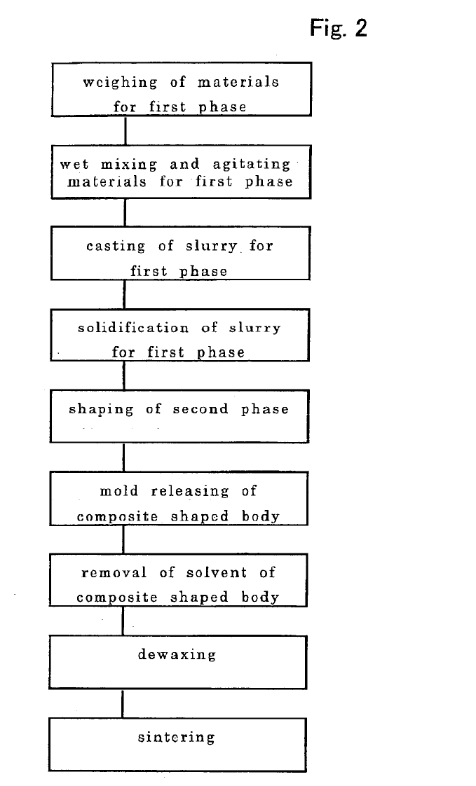

Alternatively, as shown in FIG. 2, the first phase may be shaped in advance. That is, the material of the first phase is weighed, wet mixed and agitated to obtain a slurry. The slurry for the first phase is supplied into a mold and solidified to obtain a shaped body for the first phase. The shaped body for the first phase is removed from the mold, and the second phase is then shaped to produce the composite shaped body.

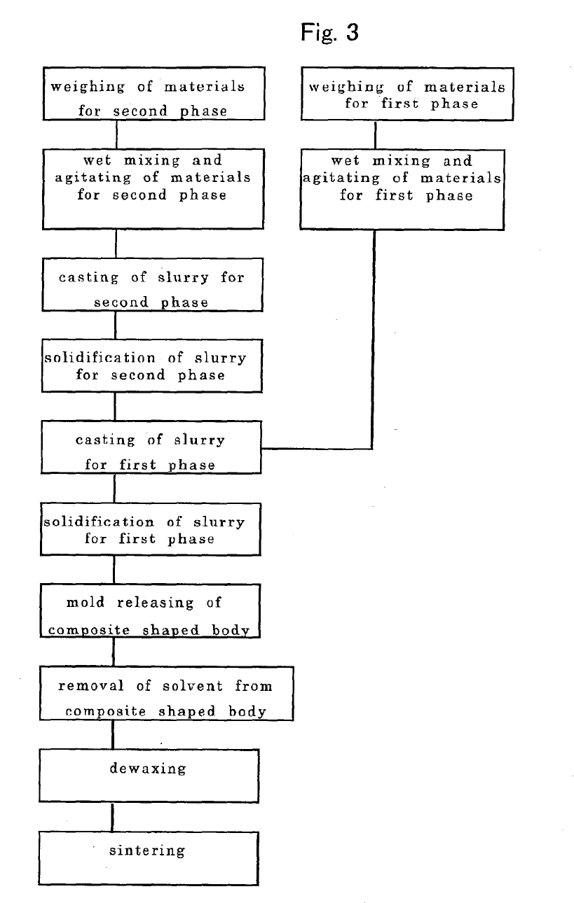

Most preferably, as shown in FIG. 3, the second phase is shaped by gel cast molding to obtained a shaped body, which is then contained in a mold. The slurry for the first phase is then supplied into the mold and shaped by gel cast molding. In this embodiment, the dimensional precisions of the sintered and shaped bodies of the present invention may be further improved, and the peel strength of the first and second phases in the sintered body may be considerably improved.

In the invention, the precisions of the shaped and sintered bodies mean differences between the respective designed dimensions and the dimensions of the actually obtained shaped and sintered bodies. This includes the following two cases.

(1) A Difference Between the Designed Dimension and an Average Value of Dimension of Actually Produced Articles in Each of the Shaped and Sintered Bodies

That is, the measured values of dimensions may be deviated upon measured positions in each of the actually obtained shaped and sintered bodies. As the difference between the designed value and the average of actually measured values is smaller, the dimensional precision is better.

Particularly when the first shaped phase is produced, as the designed value of the thickness is larger, the difference between the designed and measured values of the thickness tends to be larger. It is possible, however, to reduce the difference of the designed value and measured value (average) of the thickness in the first phase, by shaping the first phase by gel cast molding.

Particularly, according to the present invention, the thickness of the first phase (“TA” or TB” in FIG. 4(a)) may be increased to 0.5 mm or more, and further to 1.0 mm or more. Even in this embodiment, the difference between the designed value and measured value (average) of the thickness may be reduced.

(2) Deviation of Dimension in the Shaped Body Actually Produced

The measured value of the dimension may be deviated upon positions in each of the shaped and sintered bodies. As the deviation of the measured values is smaller, the dimensional precision is higher. It is possible to reduce the deviation of the measured value of the thickness in the first phase, by shaping the first phase by gel cast molding.

There is no particular restriction on the inorganic powder for generating the shaped and sintered bodies of the present invention, as long as the powder may be sintered by heating to form a sintered body. The inorganic powder includes ceramic powder, metal powder, a powder of ceramic-metal composite material and a powder mixture thereof. The ceramics includes oxide series ceramics such as alumina, zirconia, titania, silica, magnesia, ferrite, cordielite and oxides of rare elements such as yttria; composite oxides such as barium titanate, strontium titanate, lead zirconate titanate, manganites of rare earth elements and chromites of rare earth elements; nitride series ceramics such as aluminum nitride, silicon nitride and sialon; carbide series ceramics such as silicon carbide, boron carbide, and tungsten carbide; and fluoride series ceramics such as beryllium fluoride, magnesium fluoride, calcium fluoride, strontium fluoride, barium fluoride and so on. Further, the metal includes iron series metals such as iron, stainless steel and carbonyl iron, non-iron metals such as titanium, copper and aluminum or alloys of non-iron metals. The inorganic powder further includes graphite, glass and carbon.

Gel casting process may be carried out as follows.

(1) A gelling agent and inorganic powder are dispersed in a dispersing agent to produce a slurry. The gelling agent includes polyvinyl alcohol and a prepolymer such as an epoxy resin and phenol resin. The slurry is then supplied into a mold and subjected to three dimensional cross linking reaction with a cross linking agent to solidify the slurry.

(2) An organic dispersing medium having a reactive functional group and a gelling agent are chemically bonded with each other to solidity the slurry. The process is described in Japanese patent publication 2001-335371A (US publication 2002-0033565).

According to the process, it is preferred to use an organic dispersing medium having two or more reactive functional groups. Further, 60 weight percent or more of the whole dispersing medium may preferably be an organic dispersing medium having a reactive functional group.

The organic dispersing medium having a reactive functional group may preferably have a viscosity of 20 cps or lower at 20° C. The gelling agent may preferably have a viscosity of 3000 cps or lower at 20° C. Specifically, it is preferred to react the organic dispersing medium having two or more ester bonds with the gelling agent having an isacyanate group and/or an isothiocyanate group to solidify the slurry.

An organic dispersing medium satisfies the following two conditions.

(1) The medium is a liquid substance capable of chemically reacting with the gelling agent to solidify the slurry.

(2) The medium is capable of producing the slurry with a high liquidity for the ease of supply into the mold

The organic dispersing medium necessarily has a reactive functional group, such as hydroxyl, carboxyl and amino groups capable of reacting with the gelling agent in the molecule for solidifying the slurry.

The organic dispersing medium has at least one reactive functional group. The organic dispersing medium may preferably have two or more reactive functional groups for accelerating the solidification of the slurry.

The liquid substance having two or more reactive functional groups includes a polyalcohol (ex. A diol such as ethylene glycol, a triol such as glycerin or the like) and polybasic acid (dicarboxylic acid or the like).

It is not necessary that the reactive functional groups in the molecule may be the same or different kind of functional groups with each other. Further, many reactive functional groups may be present such as polyethylene glycol.

On the other hand, when a slurry with a high liquidity is produced, it is preferred to use a liquid substance having a viscosity as low as possible. The substance may preferably have a viscosity of 20 cps or lower at 20° C.

The above polyalcohol and polybasic acid may have a high viscosity due to the formation of hydrogen bonds. In this case, even when the polyalcohol or polybasic acid is capable of solidifying the slurry, they are not suitable as the reactive dispersing medium. In this case, it is preferred to use, as the organic dispersing medium, an ester having two or more ester bonds such as a polybasic ester (for example, dimethyl glutarate), or acid ester of a polyalcohol (such as triacetin).

Although an ester is relatively stable, it has a low viscosity and may easily react with the gelling agent having a high reactivity. Such ester may satisfy the above two conditions. Particularly, an ester having 20 or lower carbon atoms have a low viscosity, and may be suitably used as the reactive dispersing medium.

In the embodiment, a non-reactive dispersing medium may be also used. The dispersing agent may preferably be an ether, hydrocarbon, toluene or the like.

Further, when an organic substance is used as the non-reactive dispersing agent, preferably 60 weight percent or more, more preferably 85 weight percent or more of the whole dispersing agent may be occupied by the reactive dispersing agent for assuring the reaction efficiency with the gelling agent.

The reactive gelling agent is described in Japanese patent publication 2001-335371A (US publication 2002-0033565).

Specifically, the reactive gelling agent is a substance capable of reacting with the dispersing medium to solidify the slurry. The gelling agent of the present invention may be any substances, as long as it has a reactive functional group which may be chemically reacted with the dispersing medium. The gelling agent may be a monomer, an oligomer, or a prepolymer capable of cross linking three-dimensionally such as polyvinyl alcohol, an epoxy resin, phenol resin or the like.

The reactive gelling agent may preferably have a low viscosity of not larger than 3000 cps at 20° C. for assuring the liquidity of the slurry.

A prepolymer and polymer having a large average molecular weight generally have a high viscosity. According to the present invention, a monomer or oligomer having a lower molecular weight, such as an average molecular weight (GPC method) of not larger than 2000, may be preferably used.

Further, the “viscosity” means a viscosity of the gelling agent itself (viscosity of 100 percent gelling agent) and does not mean the viscosity of a commercial solution containing a gelling agent for example, viscosity of an aqueous solution of a gelling agent).

The reactive functional group of the gelling agent of the present invention may be selected considering the reactivity with the reactive dispersing medium. For example, when an ester having a relatively low reactivity is used as the reactive dispersing medium, the gelling agent having a highly reactive functional group such as an isocyanate group (—N═C—O) and/or an isothiocyanate group (—N═C═S) may be preferably used.

An isocyanate group is generally reacted with an diol or diamine. An diol generally has, however, a high viscosity as described above. A diamine is highly reactive so that the slurry may be solidified before the supply into the mold.

Taking such a matter into consideration, a slurry is preferable to be solidified by reaction of a reactive dispersion medium having ester bonds and a gelling agent having an isocyanate group and/or an isothiocyanate group. In order to obtain a further sufficient solidified state, a slurry is more preferable to be solidified by reaction of a reactive dispersion medium having two or more ester bonds and a gelling agent having isocyanate group and/or an isothiocyanate group.

Examples of the gelling agent having isocyanate group and/or isothiocyanate group are MDI (4,4′-diphenylmethane diisocyanate) type isocyanate (resin), HDI (hexamethylene diisocyanate) type isocyanate (resin), TDI (tolylene diisocyanate) type isocyanate (resin), IPDI (isophorone diisocyanate) type isocyanate (resin), and an isothiocyanate (resin).

Additionally, in the present invention, other functional groups may preferably be introduced into the foregoing basic chemical structures while taking the chemical characteristics such as compatibility with the reactive dispersion medium and the like into consideration. For example, in the case of reaction with a reactive dispersion medium having ester bonds, it is preferable to introduce a hydrophilic functional group from a viewpoint of improvement of homogeneity at the time of mixing by increasing the compatibility with esters.

Further, in the present invention, reactive functional groups other than isocyanate and isothiocyanate groups may be introduced into a molecule, and isocyanate group and isothiocyanate group may coexist. Furthermore, as a polyisocyanate, a large number of reactive functional groups may exist together.

The slurry for shaping the first or second phase may be produced as follows.

(1) The inorganic powder is dispersed into the dispersing medium to produce the slurry, into which the gelling agent is added.

(2) The inorganic powder and gelling agent were added to the dispersing agent at the same time.

The slurry way preferably have a viscosity at 20° C. of 30000 cps or less, more preferably 20000 cps or less, for improving the workability when the slurry is filled into a mold. The viscosity of the slurry may be adjusted by controlling the viscosities of the aforementioned reactive dispersing medium and gelling agent, the kind of the powder, amount of the dispersing agent and content of the slurry (weight percent of the powder based on the whole volume of the slurry).

If the content of the slurry is too low, however, the density of the shaped body is reduced, leading to the reduction of the strength of the shaped body, crack formation during the drying and sintering processes and deformation due to the increase of the shrinkage. Normally, the content of the slurry may preferably be in a range of 25 to 75 volume percent, and more preferably be in a range of 35 to 75 volume percent, for reducing cracks due to the shrinkage during a drying process.

Further, various additives may be added to the slurry for shaping. Such additives include a catalyst for accelerating the reaction of the dispersing medium and gelling agent, a dispersing agent for facilitating the production of the slurry, an anti-foaming agent, a detergent, and a sintering aid for improving the properties of the sintering body.

In a preferred embodiment, the difference of the thermal expansion coefficients of the first and second phases at 1500° C. is 0.5 ppm/° C. or lower. It is thus possible to effectively prevent crack formation and peeling in the sintered body, leading to the improvement of the production yield.

Further in a preferred embodiment, the thickness of the first phase is different from that of the second phase, and the thicker phase has a larger thermal expansion coefficient at 1500° C. The thickness of each of the first and second phases means a dimension in the direction substantially perpendicular to the interface between the first and second phases. For example in FIG. 4(a), the dimension TA or TB of the first phase 2 or second phase 3 in the direction substantially perpendicular to the interface 4 means the thickness of each phase. Further in the example of FIG. 4(b), the dimension TA or TR of the first phase 12 or second phase 13 in the direction substantially perpendicular to the interface 4 means the thickness of each phase.

It has been found that, when the thicker phase has a larger thermal expansion coefficient, cracks and peeling may be effectively reduced after the sintering process. In this embodiment, it is proved that the peeling and cracks may be prevented, even when the difference of thermal expansion coefficients of the first and second phases is 1.0 ppm/ ° C. or more.

In this embodiment, the thicker phase may preferably have a thickness of 2 mm or more, and more preferably have a: thickness of 4 mm or more, for facilitating the handling. The thickness of the thicker phase is not particularly limited. The minimum thickness of the thicker phase may preferably be 100 mm or smaller on the viewpoint of the sinterability. Further, the ratio of the thickness of the thicker phase to that of the thinner phase may preferably be not lower than 4, and more preferably be not lower than 6.

According to the present invention, the peeling may be prevented between the first and second phases, even when the area of the interface of the first and second phases is large. The present invention is thus suitable for the production of the sintered body having a large surface area. According to the process of the present invention, the sintered body having an area of 100 cm² or more, for example 6400 cm , may be produced

The present invention is suitable to the sintered body having the following material. That is, one of the first and second phases is made of a ceramics containing alumina, and the other is made of a ceramics containing an yttria-alumina composite oxide.

In the ceramics containing an yttria-alumina composite oxide, the composite oxide includes the followings.

(1) Y₃Al₅O₂ (YAG: 3Y₂O.5Al₂O)

This contains yttria and alumina in a proportion of 33:5, and has garnet crystal structure.

(2) YAlO₃ (YAL: Y₂O₃.Al₂O₃)

This has perovskite crystal structure.

(3) Y₄Al₂O₉ (YAM: 2Y₂O₃.Al₂O₃)

This belongs to monoclinic system.

Additional components and impurities other than the yttria-alumina composite oxide are not excluded. However, a total content of the components other than the composite oxide may preferably be 10% by weight or less.

Furthermore, in the above ceramics containing alumina, the yttria-alumina composite oxide described above, a spinel type compound, a zirconium compound and a rare earth compound may be contained. In this embodiment, if the total content of these components is too large, the thermal conductivity and the material strength may be lowered. Accordingly, the content is preferable to be 10% by weight or less in total, being further preferable to be in the range of 3 to 7% by weight.

In both of the ceramics containing alumina and yttria-alumina composite oxide, the powder mixture may contain powder of a third component. However, the third component is preferable not to be detrimental to the garnet phase and is preferable to be capable of replacing yttria or alumina in the garnet phase. As such components, the followings can be cited.

La₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₈, Yb₂O₃, Lu₂O₃, MgO, CaO, SrO, ZrO , CeO₂, SiO₂, Fe₂O, and B₂O₃.

The thus obtained shaped body is then sintered to produce the sintered body of the present invention. The sintering temperature, atmosphere, temperature ascending and descending rates, and a holding time period at the maximum temperature is to be decided depending on the materials constituting the shaped body. When the shaped body is made of a ceramic material, the maximum temperature during the sintering may preferably be in a range of 1300 to 2000° C. Further, when the ceramics containing an yttria-alumina composite oxide is to be sintered, the maximum temperature may preferably be in a range of 1400 to 1700° C.

Preferred embodiments of the second and third aspects of the present invention will be described below.

In the second and third aspects of the present invention, the innermost layer comprises a corrosive ceramics including an oxide series ceramics including alumina, zirconia, titania, silica, magnesia, ferrite, cordielite and oxides of rare elements such as yttria; composite oxides such as barium titanate, strontium titanate, lead zirconate titanate, manganites of rare earth elements and chromites of rare earth elements; nitride series ceramics such as aluminum nitride, silicon nitride and sialon; carbide series ceramics such as silicon carbide, boron carbide, and tungsten carbide; and fluoride series ceramics such as beryllium fluoride, magnesium fluoride, calcium fluoride, strontium fluoride, barium fluoride and so on. The ceramics may most preferably be the yttria-alumina composite oxide described above.

In the second and third aspects of the present invention, the diameter of the hole may preferably be 1 mm or smaller, on the viewpoint of the above effects of the present invention. Further, the length of the hole may preferably be 2.4 mm or longer.

Further, in a preferred embodiment, the thickness of the innermost layer is 1 μm or larger, so as to further reduce the particle generation from the inner wall surface facing the hole. On the viewpoint, the thickness of the innermost layer may preferably be 50 μm or larger. It is more advantageous to form the innermost layer by gel cast molding by adjusting the thickness of the innermost layer to 2 mm or smaller.

In a preferred embodiment, the innermost layer comprises an yttrium-aluminum garnet, and the corrosion resistant member has a portion adjacent to the innermost layer. The adjacent portion contains alumina in an amount of not lower than 50 weight percent. In this embodiment, the adjacent portion may contain the above yttria-alumina composite oxide, a spinel compound, a zirconium compound or a rare earth compound.

The third embodiment of the present invention provides a method of producing a ceramic member having a main body having a hole formed therein and an innermost layer provided on the inner wall face of the member and facing the hole. A mold is used having an outer frame forming a shaping space and a protrusion protruding into the space. A first gel cast slurry generating the innermost layer upon sintering is adhered to the protrusion to solidify the first gel cast slurry. A second gel cast slurry generating the main body upon sintering is then cast into the space to solidify the second gel cast slurry so that shaped body is obtained. The shaped body is sintered to provide a ceramic member having the main body and the innermost layer.

According to the method, in the ceramic member having small holes formed therein, the innermost layer facing the hole may be easily shaped with an excellent precision, so that the thickness of the innermost layer may be made uniform.

Further, the above description for the first aspect of the invention may be thoroughly applied to each of the second and third aspects of the present invention. That is, in the second and third aspects of the present invention, the innermost -layer is specified as the first phase and main body is specified as the second phase. In this case, the descriptions about the first and second phases may be applied to the corrosion resistant and ceramic members of the second and third aspects.

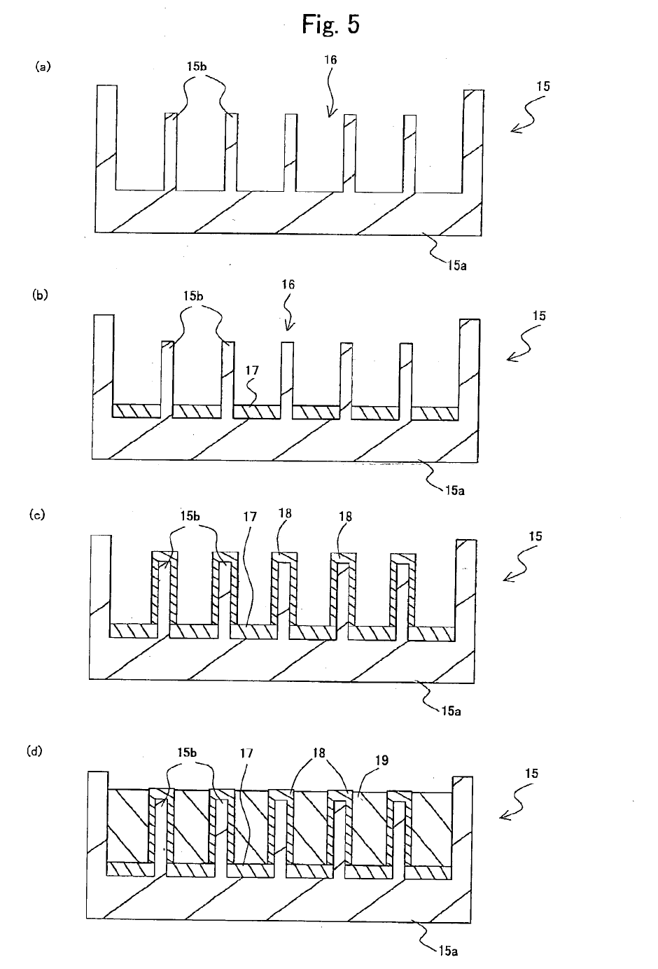

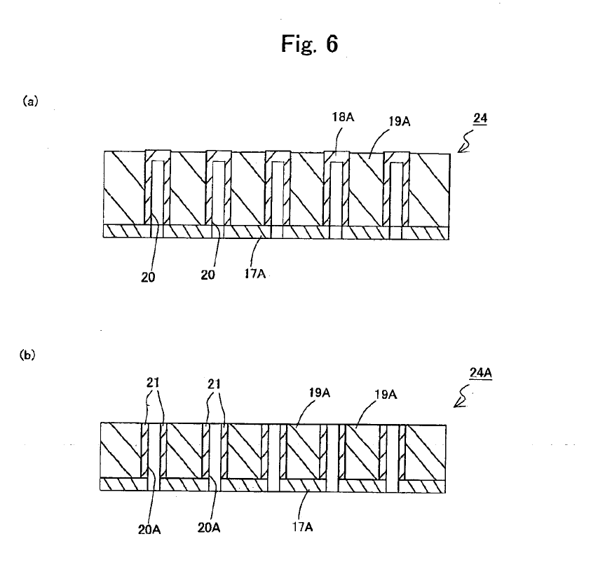

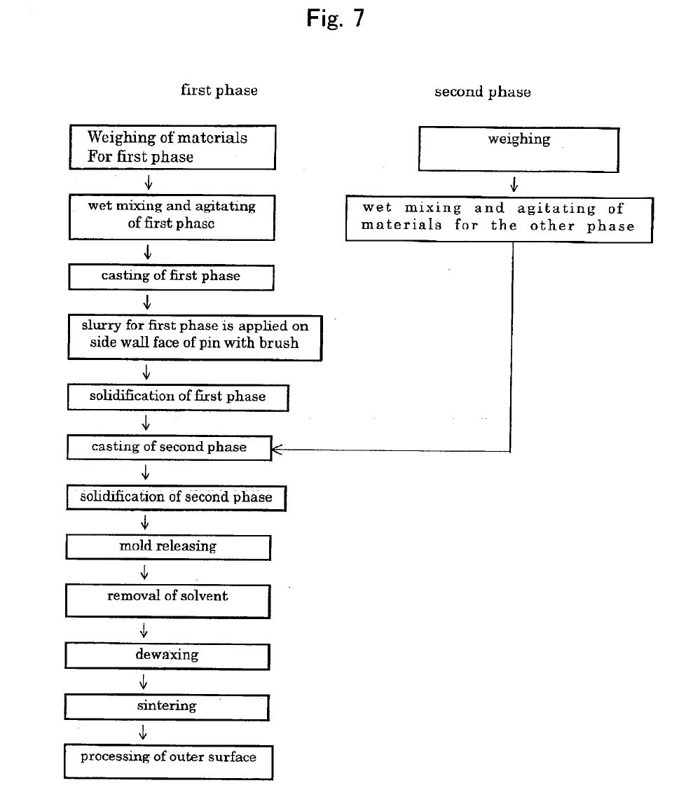

FIGS. 5 and 6 are cross sectional views schematically showing steps in the manufacturing process according to the first, second and third aspects of the present invention. FIG. 7 shows a flow chart of the manufacturing process of the present embodiment. This process basically belongs to the first aspect of the present invention, and its descriptions may be applied to the present embodiment.

According to the present embodiment, the first phase constitutes the innermost layer of ceramic members 24, 24A, and the second phase constitutes a main body 19A. That is, raw materials for the first phase (innermost layer) is weighed, mixed, agitated and supplied into a mold. On the other hand, a mold shown in FIG. 5(a) is prepared. The mold 15 has an outer frame 15a and a predetermined number of pins 15b. The pins 15b are protruded into a space for molding 16. Preferably, a gel cast molding material 17 of ceramic is supplied at a predetermined height in the mold (see FIG. 5(b)).

The gel cast molding material for the first phase is applied to the outer surfaces of the protrusions 15b to form adhered layers 18 shown in FIG. 5(c). The adhered layers 18 may be formed by any processes. Preferably, an applicator such as a brush is used to apply the gel cast molding material onto the surfaces of the pins. The material may be applied once or twice or more. It is possible to increase the thickness of the adhered and innermost layers by increasing the number of repetition of the application process. The shape of the protrusion is not particularly limited, as long as the hole may be shaped.

On the other hand, the gel cast molding material for the second phase is supplied into the molding space 16 of the mold 15 to form the second shaped phase shown in FIG. 5(d). The second shaped phase is then solidified to obtain a shaped body, which is then removed from the mold. The solvent in the shaped body is then removed. The conditions such as the compositions of the materials for the first and second phases, concentration and manufacturing process are the same as those described in the description of the first aspect of the invention.

The shaped body is then dowaxed and sintered to obtain a sintered body 24 shown in FIG. 6(a). The sintered body 24 has a main body 19A (second phase), a predetermined number of innermost layers 18A (first phase) formed in the main body and a surface phase 17 The sealing portions of the holes 20 in the sintered body 24 are removed by surface grinding to obtain a sintered article 24A shown in FIG. 6(b). The sintered body 24A has the main body 19A, many small holes 20A passing through the main body 19A, innermost layers 21 facing the holes 20A and surface layer 17A.

### EXAMPLES

(Experiment A According to the First Aspect of the Invention: Test Numbers 1 to 9)

(Test Number 1)

The composite sintered body 1 shown in FIG. 4(a) was produced. In the present example, an alumina substrate 3 and YAG (Yttrium-aluminum gairnet) film 2 were continuously formed by gel cast molding process.

Specifically, 100 weight parts of alumina powder (“AES-11C” supplied by Sumitomo Denko Inc.)), 25 weight parts of dimethyl glutarate (reactive dispersing medium), and 5 weight parts of an aliphatic polyisocyanate (gelling agent) were mixed in a pot mill to obtain a slurry for an alumina substrate. The slurry was filled in a mold, stood for a specific time period so that the slurry was gelled and solidified to produce the shaped portion for the alumina substrate. The designed value of the thickness of the alumina substrate is 10.0 mm. The planar shape of the shaped body is a square having a length of 70 mm and width of 70 mm.

Further, 100 weight parts of yttrium-aluminum garnet powder, 7 weight parts of dimethyl glutarate (reactive dispersing medium) and 6 weight parts of an aliphatic polyisocyanate (gelling agent) were mixed in a pot mill to obtain a slurry for a YAG film. The slurry was then filled in a mold and solidified to obtain a shaped portion for the YAG film. The designed value of thickness for the YAG film was 1.0 mm.

The thus obtained composite shaped body was removed from the mold, and heat treated at 250° C. for 5 hours to remove the solvent, dewaxed at 1000° C. for 2 hours, and then sintered at 1600° C. for 6 hours to obtain a composite sintered body.

The thickness of the alumina substrate 3 and that of the YAG film 2 were measured at five points to obtain an average thickness (mm) and deviation of film thickness (%). The deviation of film thickness is defined as (maximum thickness minus minimum thickness)/average thickness. Open porosities of the alumina substrate and YAG film were measured by Archimedes's method. Further, the peeling strength of the YAG film was measured by Sebastian test. The results of measurements were shown in Table 1.

table 1

| | production process | | | | | | | | | |
|---|---|---|---|---|---|---|---|---|---|---|
| | | alumina | | properties | | | | | | |
| | | substrate | | alumina substrate | | | | | | |
| | alumina | directly | | average | | | YAG film | | | |
| Experi- | substrate | before | YAG film | film | deviation of | open | film | deviation | open | peel |
| mental | production | formation | production | thickness | film | porosity | thickness | of film | porosity | strength |
| number | process | of YAG | process | (mm) | thickness | (Vol %) | (mm) | thickness | (Vol %) | (MPa) |
| 1 | gel cast molding | shaped | gel cast | 10.3 | 0.002 | 0 | 0.99 | 0.051 | 0 | >50 |
| | | body | molding | | | | | | | |
| 2 | CIP | shaped | gel cast | 11.8 | 0.22 | 0.1 | 1.02 | 0.059 | 0 | >50 |
| | | body | molding | | | | | | | |
| 3 | slip casting | shaped | gel cast | 8.9 | 0.03 | 1.6 | 0.98 | 0.071 | 0 | >50 |
| | | body | molding | | | | | | | |
| 4 | gel cast molding | shaped | slurry dipping | 10.1 | 0.0018 | 0 | 0.3 | 0.333 | 2.5 | >50 |
| 5 | slip casting | shaped | slurry dipping | 8.5 | 0.026 | 1.6 | 0.4 | 0.300 | 2.6 | >50 |
| | | body | | | | | | | | |
| 6 | CIP | shaped | slurry dipping | 11.3 | 0.24 | 0.1 | 0.3 | 0.433 | 2.5 | >50 |
| | | body | | | | | | | | |
| 7 | gel cast molding | sintered | plasma | 10.2 | 0.002 | 0 | 0.3 | 0.333 | 4.2 | 43 |
| | | body | sprayng | | | | | | | |
| 8 | CIP | sintered | plasma | 11.7 | 0.28 | 0.1 | 0.2 | 0.400 | 4.6 | 40 |
| | | body | spraying | | | | | | | |
| 9 | slip casting | sintered | plasma | 8.7 | 0.031 | 1.5 | 0.2 | 0.350 | 4.5 | 44 |
| | | body | spraying | | | | | | | |

(Test Numbers 2 to 6)

The sintered body made of the same material as the experiment 1 was produced. In the experiment 2, however, the alumina substrate was shaped with cold isostatic pressing (CIP) and YAG film was shaped with gel cast molding. In the test number 3, the alumina substrate was shaped with slip casting, and the YAG film was shaped with gel cast molding. In the test number 4, the alumina substrate was shaped with gel cast molding and the YAG film was shaped with slurry dipping. In the test number 5, the alumina substrate was shaped with slip casting and the YAG film was shaped with slurry dipping. In the test number 6, the alumina substrate was shaped with CIP and the YAG film was shaped with slurry dipping.

When the alumina substrate was shaped with CIP, 100 weight parts of the alumina powder used in the experiment 1 and 4 weight parts of polyvinyl alcohol (12 percent solution) were mixed, dry pressed at 100 kgf/cm² and subjected to cold isostatic pressing at 2 ton/cm². When the alumina substrate was shaped with slip casting, 100 weight parts of the alumina powder used in the experiment 1, 0.4 weight parts of CMC (carboxymethyl cellulose) and 35 weight parts of water were mixed in a pot mill, cast and removed from a mold. When the YAG film was shaped with slurry dipping, 100 weight parts of yttrium-aluminum garnet powder, 10 weight parts of polyvinyl alcohol (12 percent solution) and 20 weight parts of water were weighed and mixed in a pot mill to obtain a slurry. The shaped body for the alumina substrate was dipped into the slurry to obtain a composite shaped body. Each shaped body was then sintered as described in the experiment 1 to obtain a sintered body of each example.

(Test Numbers 7, 8 and 9)

In the test numbers 7, 8 and 9, the alumina substrates were shaped with gel cast molding, CIP or slip casting, dewaxed at 1000 DC for 2 hours, and sintered at 1600° C. for 6 hours to obtain each alumina substrate (sintered body). A YAG film was formed on each alumina substrate by means of plasma spraying. During the plasma spraying process, 57 weight parts of Y203 powder (“PC-YH” supplied by Nippon kenmazai Inc.) and A1203 powder (“K-16T” supplied by Showa Denko Inc.) were mixed to obtain a mixed powder, which was then plasma sprayed onto each sintered body to obtain each composite shaped body. Each shaped body was then heat treated at 1600° C. for 6 hours to obtain each sintered body.

In the experiment 1 of the present invention, both of the alumina substrate and YAG film were shaped with gel cast molding. In this case, the average thickness (measured) of each of the substrate and film was proved to be near the designed value and the deviation of the thickness was reduced. The peeling strength of the film was also improved. In the test numbers 2 and 3, the dimensional precision of the thickness of the YAG film was excellent and the peeling strength of the film was high. Further in the test numbers 1 to 3, each film had an extremely low open porosity. In the test number 4 of the present invention, the alumina substrate had an excellent dimensional precision and the peeling strength of the film was high. In the test numbers 5 and 6 out of the present invention, although the film had a high peeling strength, the dimensional precisions of the alumina substrate and YAG film were low. The thickness of the YAG film was particularly small. In the test numbers 7, 8 and 9, the YAG film had a low dimensional precision, the open porosity was large, and the peeling strength was low.

(Experiment B According to the First Aspect of the Present Invention)

Each sintered body was produced as shown in each test number shown in table 2. The material for the substrate was a composite ceramics of alumina and 5 weight percent of spine and the designed value of the thickness of the substrate was set at 10 mm. The YAG film was made of yttrium-aluminum garnet, and its designed value was set at 1 mm. The alumina substrate was shaped with gel cast molding or CIP process according the same procedure as the Experiment A. The YAG film was shaped with gel cast molding, slurry dipping or plasma spraying according to the same process as the experiment A. The thus obtained shaped body were sintered according to the same procedure as the experiment A. The area of the interface of the alumina substrate and YAG film was changed as shown instable 2. The properties of the thus obtained sintered body were measured and the results were shown in table 2.

Table 2

| | production process | | | | | | | | | | |
|---|---|---|---|---|---|---|---|---|---|---|---|
| | | alumina | | | | | | | | | |
| | | substrate | | | properties | | | | | | |
| | | directly | | | alumina substrate | | | | | | |
| | alumina | before | | | average | | | YAG film | | | |
| experi- | substrate | information | YAG film | area of | film | deviation | open | film | deviation | open | |
| mental | production | of YAG | production | interface | thickness | of film | porosity | thickness | of film | porosity | cracks |
| number | process | film | process | (cm²) | (mm) | thickness | (Vol % | (mm) | thickness | (Vol %) | peeling |
| 1 | gel cast | shaped | gel cast | 100 | 10 | 0.002 | 0 | 1.01 | 0.005 | 0 | ◯ |
| | molding | body | molding | | | | | | | | |
| 2 | gel cast | shaped | gel cast | 200 | 10.2 | 0.002 | 0.1 | 1 | 0.050 | 0 | ◯ |
| | molding | body | molding | | | | | | | | |
| 3 | gel cast | shaped | gel cast | 400 | 9.8 | 0.002 | 0 | 0.99 | 0.005 | 0 | ◯ |
| | molding | body | molding | | | | | | | | |
| 4 | gel cast | shaped | gel cast | 800 | 9.9 | 0.001 | 0 | 1.01 | 0.004 | 0 | ◯ |
| | molding | body | molding | | | | | | | | |
| 5 | gel cast | shaped | gel cast | 1600 | 10 | 0.001 | 0.1 | 1 | 0.003 | 0 | ◯ |
| | molding | body | molding | | | | | | | | |
| 6 | gel cast | shaped | gel cast | 3200 | 10.2 | 0.002 | 0 | 1 | 0.003 | 0 | ◯ |
| | molding | body | molding | | | | | | | | |
| 7 | gel cast | shaped | gel cast | 6400 | 10.1 | 0.002 | 0 | 1.01 | 0.003 | 0 | ◯ |
| | molding | body | molding | | | | | | | | |
| 8 | CIP | shaped | slurry | 50 | 118 | 0.24 | 0.2 | 0.3 | 0.432 | 2.5 | ◯ |
| | | body | dipping | | | | | | | | |
| 9 | CIP | shaped | slurry | 100 | 118 | 0.26 | 0.3 | 0.2 | 0.335 | 2.6 | X |
| | | body | dipping | | | | | | | | |
| 10 | CIP | sintered | plasma | 50 | 117 | 0.28 | 0.2 | 0.2 | 0.401 | 4.6 | ◯ |
| | | body | spraying | | | | | | | | |
| 11 | CIP | sintered | plasma | 100 | 11.9 | 0.24 | 0.3 | 0.3 | 0.356 | 4.6 | X |
| | | body | spraying | | | | | | | | |

dimensional precision's of the alumina substrate and YACG film was high, as well as the peeling or crack of the YAG film was not observed. In the test numbers 8 and 9, the alumina substrate had a low dimensional precision, and Ma thick film of YAG cannot be formed. Further in the test number 9, the area of the interface was 100 cm², and cracks and peeling were observed in the YAG film. On the contrary, in the test numbers 1 to 7 according to the present invention, even when the area of the interface was 100 cm² or more, particularly 6400 cm² or more, cracks or peeling of the YAG film was not observed. In the test numbers 10 and 11, the alumina substrate had a low dimensional precision and a thick film of YAG film may not be produced. Further in the test number 11, the area of the interface was 100 cm², and cracks and peeling of the YAG film were observed.

(Experiment C According to the First Aspect)

The substrate and YAG film were continuously shaped according to the same procedure as the experiment A to produce a composite shaped body. The materials of the substrate 3 and film 2 were changed as shown in table 3. Each shaped body was sintered to obtain each sintered body. The thermal expansion coefficient in a range of room temperature to 1500° C. of each of the substrate 3 and film 2, the thermal conductivity of the substrate 3, and occurences of cracks and peeling in the film 2 were shown in table 3. The designed value of thickness of the substrate 3 was 10 mm and the designed value of thickness of the film 2 was 1 mm.

Table 3

| | | film 2 | | incidence of cracks |
|---|---|---|---|---|
| substrate 3 | thermal | | thermal | and peeling of film 2 |

| | | | | | | |
|---|---|---|---|---|---|---|
| | | Thermal expansion | conductivity | | expansion | (number of off- |
| Experi- | | coefficient | W/mk | | coefficient | specification |
| mental | | (ppm/° C.) | room | | (ppm/° C.) | products/′number of |
| number | material | RT-1500° C. | temperature | material | RT-1500° C. | products) |

| | | | | | | |
|---|---|---|---|---|---|---|
| 1 | Al203 | 8.8 | 33 | YAG | 9.3 | 2/10 |
| 2 | Al203 + 3 wt % spinel | 9 | 31 | YAG | 9.3 | 1/10 |
| 3 | Al203 + 5 wt % spinel | 9.4 | 30 | YAG | 9.3 | 0/10 |
| 4 | Al208 + 10 wt % spinel | 9.8 | 28 | NAG | 9.3 | 0/10 |
| 5 | Al203 + 20 wt % spinel | 10.1 | 26 | YAG | 9.3 | 0/10 |
| 6 | Al203 + 30 wt % spinel | 10.3 | 24 | YAG | 9.3 | 0/10 |
| 7 | Al203 | 8.8 | 33 | 8 molYSZ | 10.5 | 10/10 |
| 8 | Al203 + 9 wt % spinel | 9 | 31 | 8 molYSZ | 10.5 | 10/10 |
| 9 | Al203 + 5 wt % spinel | 9.4 | 30 | 8 molYSZ | 10.5 | 10/10 |
| 10 | Al203 + 10 wt % spinel | 9.8 | 28 | 8 molYSZ | 10.5 | 10/10 |
| 11 | Al203 + 20 wt % spinel | 10.1 | 26 | 8 molYSZ | 10.5 | 2/10 |
| 12 | Al203 + 30 wt % spinel | 10.3 | 24 | 8 molYSZ | 10.5 | 1/10 |
| 13 | Al203 + 10 wt % 8YSZ | 9 | | YAG | 9.3 | 1/10 |
| 14 | Al203 + 20 wt % 8YSZ | 9.3 | | YAG | 9.3 | 0/10 |
| 15 | Al203 + 30 wt % 8YSZ9 | 6 | | YAG | 9.3 | 0/10 |
| 16 | Al203 + 10 wt % CeO2 | 9.4 | | YAG | 9.3 | 0/10 |
| 17 | Al203 + 20 wt % CeO2 | 10.3 | | YAG | 9.3 | 0/10 |
| 18 | Al203 + 30 wt % CeO2 | 10.8 | | YAG | 9.3 | 0/10 |
| 19 | mullite | 5.5 | 10 | YAG | 9.3 | 10/10 |

expansion coefficients of the substrate 3 and film 2 is 0.5 ppm/° C. or larger, it is proved that the occurences of cracks and peeling in the film 2 were considerably increased. On the other hand, when the thicker substrate 3 had a larger thermal expansion coefficient, even when the difference of the thermal expansion coefficients between the substrate 3 and film 2 is 0.5 ppm/° C. or larger, and further 1.0 ppm/° C. or larger, cracks and peeling were not observed in the film 2.

(Experiment D According to the First, Second and Third Aspects of the Present Invention)

The sintered body 24A shown in FIG. 6(b) was produced. In the present example, the alumina substrate 19A with added zirconia and the innermost layer made 21 of YAG (yttrium-aluminum garnet) were continuously produced with gel cast molding, according to a flow chart shown in FIG. 7.

(Production of Raw Materials for the First Phase (Innermost Layer))

100 weight parts of yttrium-aluminum garnet powder, 7 weight parts of an aliphatic polyisocyanate, 25 weight parts of an organic polybasic ester, 5 weight parts of triethyl amine and 0.5 weight parts of poly maleic acid were mixed and dispersed in a pot mill to obtain a slurry for the YAG film.

(Production of Materials for the Second Phase (Main Body))

Specifically, 100 weight parts of zirconia-added alumina powder, 7 weight parts of an aliphatic polyisocyanate (gelling agent), 25 weight parts of an organic polybasic acid ester, 5 weight parts of triethyl amine and 0.5 weight parts of polymaleic acid copolymer were mixed in a pot mill. A material (slurry) for the alumina main body 19 was thus obtained.

(Production of a Shaped Body)

121 pins 15b were provided on the bottom face of a metal mold having an outer diameter φ of 480 mm and a height of 5 mm in intervals of 30 mm vertically and horizontally. Each pin 15b had a dimension adjusted for providing the small hole having a predetermined diameter after the sintering process. The gel cast slurry for YAG (for the first phase) was flown into the mold to a height so that the thickness becomes a predetermined value after the sintering process (17 shown in FIG. 5(b): the viscosity was 6 poise measured by a viscometer). After that, the remaining slurry for YAG was applied on the side face of each pin 15b with a brush. Each assembly was left for the time period between 20 minutes to 1 hour. Although the viscosity of the slurry may not be measured with a viscometer, the viscosity was near that of a paste. The viscosity was also considerably increased as time passes by. The assembly was then solidified in air for 2 hours. Alternatively, in the samples of the comparative examples, the slurry was not applied with a brush onto the surface of each pin.

After the slurry 19 for the second phase (main body) was prepared and left for 30 minutes, the slurry was then flown into the mold to a height so that a predetermined thickness was obtained after the sintering process. The slurry was then solidified for about 2 hours. The shaped portion 19 for the alumina main body 19A was thus produced. The thus obtained shaped body was removed from the metal mold 15 and dried in air for one day.

The thus obtained sintered body was removed from the mold, heat treated at 250° C. for 5 hours to remove the solvent, dewaxed at 1000° C. for 2 hours, and sintered at 1600° C. for 6 hours. The composite sintered body 24 was thus obtained.

The main body 19A had a diameter of 400 mm and composed of alumina containing 25 weight percent of 8 mol percent Y₂O₃ stabilized zirconia. The YAG layer 17A had a diameter of 400 mm 121 open through holes 20A were formed each having a specific diameter. The holes are arranged two dimensionally in 11 rows and 11 lines in intervals of 25 mm in a plate face.

(Measurement of Particles)

Each of the sintered bodies of the inventive and comparative examples was set in a system for testing corrosion with the YAG film 17A orientating downwardly. A spacer with a diameter of 10 mm and an 8-inch Si wafer were set under the sintered body in this order. Cl₂ gas was supplied to a space over the wafer through the holes 20A from the side of alumina containing zirconia with a carrier gas. The flow rate of Cl₂ gas was 300 sccm and the flow rate of the carrier gas (argon gas) was 100 sccm. The pressure of the gas was 0.1 torr. RF of 800 W was supplied. The wafer was held for 10 minutes. “SP-1” supplied by Tencor Inc. was used to count the number of particles on the wafer. The results were shown table 4.

Table 4

| | | | | | | | | | | | maximum |
|---|---|---|---|---|---|---|---|---|---|---|---|
| | | | | | | | | | | | amount of |
| | dimension of | | | | | | | thickness of | | incidence of | tipping/ |
| Experi- | small hole | | first phase | | | | | YAG on inner | | particles | minimum |
| mental | diameter | length | | film | second phase | | | well surface of | | (counts/8 inch | amount of |
| No. | mm | mm | material | thickness | material | thickness | | small hole | | wafer | tipping |
| 1 | 0.5 | 3 | YAG | 1 mm | YSZ + alumina | 2 | mm | 0.5 | mm | 60 | 1.2 |
| 2 | 0.5 | 3 | YAG | 1 mm | YSZ + alumina | 2 | mm | 0 | mm | 1500 | 1.3 |
| 3 | 1 | 3 | YAG | 1 mm | YSZ + alumina | 2 | mm | 0.5 | mm | 85 | 1.2 |
| 4 | 2 | 3 | YAG | 1 mm | YSZ + alumina | 2 | mm | 0.5 | mm | 105 | 1.4 |
| 5 | 2.5 | 3 | YAG | 1 mm | YSZ + alumina | 2 | mm | 0.5 | mm | 750 | 2.0 |
| 6 | 0.5 | 2.4 | YAG | 1 mm | Ysz + alumina | 1.4 | mm | 0.5 | mm | 75 | 1.4 |
| 7 | 0.5 | 2 | YAG | 1 mm | YSZ + alumina | 1 | mm | 0.5 | mm | 150 | 1.6 |
| 8 | 0.5 | 1.5 | YAG | 1 mm | YSZ + alumina | 0.5 | mm | 0.5 | mm | 250 | 2.0 |
| 9 | 0.5 | 3 | YAG | 1 mm | YSZ + alumina | 2 | mm | 0.5 | mm | 70 | 1.4 |
| 10 | 0.5 | 3 | YAG | 1 mm | YSZ + alumina | 2 | mm | 0.001 | mm | 140 | 1.5 |
| 11 | 0.5 | 3 | YAG | 1 mm | YSZ + alumina | 2 | mm | 0.0005 | mm | 1050 1.5 | |

particles were counted. In the test numbers 3, 4, 6, 7, 9 and 10, the number of particles was reduced. In the test number 5 of comparative example, the diameter of the hole was enlarged, and the number of particles was considerably increased as well as etching ratio. In the test number 8 of comparative example, the hole is shorter, and the number of particles and etching ratio were large. It is considered that when the hole is too narrow, the gas flow in the hole tends to be turbulent flow, leading to particle generation. In the test number 11, the YAG layer on the inner wall surface facing the hole is too thin and the number of particles was large

(Measurement of an Amount of Tipping)

Each wafer was masked using a mask of a width of 5 mm arranged radially. A surface roughness tester “Form Talysurf 2 S4” (supplied by Taylor Hobson Inc) was used to measure the steps formed on the peripheral part of each mask on five points from the center to the periphery of the wafer in an interval of 20 mm (center, 20 mm, 40 mm, 60 mm, 80 mm). The difference between the maximum and minimum values of the heights of the steps were calculated. When the diameter of the hole is too large, uniform etching proved to be difficult. When the diameter of the hole is too small, uniform etching tends to be difficult.

After the measurement of the particles, each sample 24A was cut along a line passing through the hole 20A in the direction of the length. Consequently, the YAG film 21 having a thickness of about 0.5 mm was formed on the inner wall surface facing the hole in the test number 1, in which the YAG slurry was applied onto the pins 15b with a brush. On the other hand, such YAG layer 21 was not observed on the inner wall surface facing the hole of the sample of the test number 2.

As described above, the present invention provides a process for producing a sintered body having at least first and second phases contacting one another at an interface. According to the process, the dimensional precision and productivity of the sintered body may be improved.

The present invention has been explained referring to the preferred embodiments, however, the present invention is not limited to the illustrated embodiments which are given by way of examples only, and may be carried out in various modes without departing from the scope of the invention

1. A method or producing a sintered body comprising at least a first phase and a second phase, said first and second phases contacting one another at an interface: said method comprising the steps of
preparing a shaped body comprising a first shaped phase and a second shaped phase; and
sintering said shaped body to produce said sintered body,
wherein a slurry containing a sinterable inorganic powder, a dispersing medium and a gelling agent is filled into a mold and gelled so that said slurry is solidified to provide said first shaped phase.

2. The method of claim 1, wherein said dispersing agent is an organic dispersing medium having a reactive functional group, and said organic dispersing medium and said gelling agent are chemically bonded with each other so that said slurry is solidified.

3. The method of claim 2, wherein said organic dispersing medium has two or more said reactive functional groups.

4. The method of claim 2, wherein said organic dispersing medium is an ester, and said gelling is a compound having an isocyanate group and/or an isothiocyanate group.

5. The method of claim 1, wherein said first phase has a thickness of 0.5 mm or more.

6. The method of claim 5, wherein the difference between thermal expansion coefficients at 1500° C. of said first and second phases is 0.5 ppm/° C. or less.

7. The method of claim 1, wherein said first phase has a thickness different from that of said second phase, one phase having a larger thickness between said first and second phases has a larger thermal expansion coefficient at 1500° C. than that of the other phase having a smaller thickness.

8. The method of claim 1, wherein said interface has an area of 100 cm² or more.

9. The method of claim 1, wherein one of said first and second phases comprises a ceramics containing alumina, and the other phase comprises a ceramics containing an yttria-alumina composite oxide.

10. The method of claim 9, wherein said ceramic containing alumina further contains one or more oxide selected from the group consisting of spinel, zirconia and a rare earth oxide.

11. The method of claim 10, wherein said ceramic containing alumina further contains one or more oxide selected from the group consisting of spinel, zirconia and a rare earth oxide, in an amount of not lower than 10 weight percent.

12. The method of claim 1, wherein said first and second phases are of laminar shapes and laminated.

13. A sintered body obtained by the method of claim 1.

14. A method of producing a shaped body comprising at least a first shaped phase and a second shaped phase, said first and second shaped phases contacting one another at an interface: said method comprising the step of;
filing a slurry containing a sinterable inorganic powder, a dispersing medium and a gelling agent into a mold and gelling the slurry so that said slurry is solidified to provide said first shaped phase.

15. The method of claim 14, wherein said dispersing medium is an organic dispersing medium having a reactive functional group, and said organic dispersing medium and said gelling agent are chemically bonded with each other so that said slurry is solidified.

16. The method of claim 15, wherein said organic dispersing medium has two or more said reactive functional groups.

17. The method of claim 15, wherein said organic dispersing medium is an ester, and said gelling agent is a compound having an isocyanate group and/or an isothiocyanate group.

18. The method of claim 14, wherein said interface has an area of 100 cm² or more.

19. The method of claim 14, wherein one of said first and second shaped phases comprises a raw material of alumina, and the other comprises a raw material of an yttria-alumina composite oxide.

20. The method of claim 19, wherein one of said first and second shaped phases comprises a raw material of alumina and a raw material of one or more oxide selected from the group consisting of spinel, zirconia and a rare earth oxide.

21. The method of claim 14, wherein said first and second shaped phases are of laminar shapes and laminated.

22. A shaped body obtained by the method of claim 14.

23. A corrosion resistant member comprising a ceramic main body having a hole formed therein and an innermost layer provided on the inner wall face of said body and facing said hole, wherein said innermost layer comprises an anti-corrosive ceramics and said hole has a diameter in a range of 0.1 mm to 2 mm and a length of 2 mm or more.

24. The member of claim 23, wherein said innermost layer has a thickness of not smaller than 1 micrometer and not larger than 2 mm.

25. The member of claim 22, wherein said innermost layer comprises an yttrium-aluminum garnet, said member comprises a portion adjacent to said innermost layer, and said adjacent portion contains alumina in an amount of 50 weight percent or more.

26. A method of producing a ceramic member comprising a main body having a hole formed therein and an innermost layer provided on the inner wall face of the member and facing said hole, wherein a mold having an outer frame defining a shaping space and a protrusion protruding into said space: the method comprising the steps of,
applying a first gel cast slurry generating said innermost layer upon sintering to solidify said first gel cast slurry;
casting a second gel cast slurry generating said main body upon sintering into said space to solidify said second gel cast slurry so that a shaped body is obtained; and
sintering said shaped body to provide a ceramic member comprising said main body and said innermost layer.

27. The method of claim 26, wherein said innermost layer comprises a corrosive ceramics, said hole has a diameter in a range of 0.1 mm to 2 mm, and said hole has a length of 2 mm or more.

28. The method of claim 26, wherein said innermost layer has a thickness of not smaller than 1 micrometer and not larger than 2 mm.

29. The member of claim 26, wherein said innermost layer comprises an yttrium-aluminum garnet, said member comprises a portion adjacent to said innermost layer, and said adjacent portion contains alumina in an amount of 0.50 weight percent or more.
